(19) United States
(12) Patent Application Publication
(10) Pub. No.: US 2026/0006491 A1
(43) Pub. Date: Jan. 1, 2026

(54) Proactive Uplink Packet Dropping for 5G New Radio

(71) Applicant: Apple Inc., Cupertino, CA (US)

(72) Inventors: Ping-Heng KUO, London (GB); Fangli XU, Beijing (CN); Ralf ROSSBACH, Munich (DE)

(21) Appl. No.: 18/880,990

(22) PCT Filed: Jul. 8, 2022
(86) PCT No.: PCT/CN2022/104644

§ 371 Date: Jan. 3, 2025

(51) Int. Cl. H04W 28/06; H04L 1/1812; H04W 28/02; H04W 80/02

(52) U.S. Cl. CPC H04W 28/06; H04L 1/1812; H04W 28/0268; H04W 80/02

(57) ABSTRACT

A user equipment (UE) is configured to identify an indication in response to uplink data, the indication indicating that a first packet was not successfully delivered to a receiving entity, determine that one or more packets associated with the first packet are to be dropped by the UE based on at least the indication, wherein the first packet and the one or more packets associated with the first packet are part of a same packet data unit (PDU) set or a different PDU set and drop the one or more packets associated with the first packet.

### TECHNICAL FIELD

This Application relates generally to wireless communication, and in particular relates to proactive uplink packet dropping for 5G new radio.

### BACKGROUND

A fifth generation (5G) new radio (NR) network may support packet data unit (PDU) set transmission for extended reality (XR). A PDU set may consist of multiple packets comprising at least one critical packet. If the critical packet is not successfully delivered, the other packets in the PDU set may not be useful to the receiving entity even if they are successfully delivered. A packet dropping scheme may be implemented by a user equipment (UE) to avoid unnecessary packet transmission when a critical packet of a PDU set is not successfully delivered to the receiving entity.

### SUMMARY

Some exemplary embodiments are related to a processor of a user equipment (UE) configured to perform operations. The operations include identifying an indication in response to uplink data, the indication indicating that a first packet was not successfully delivered to a receiving entity, determining that one or more packets associated with the first packet are to be dropped by the UE based on at least the indication, wherein the first packet and the one or more packets associated with the first packet are part of a same packet data unit (PDU) set or a different PDU set and dropping the one or more packets associated with the first packet.

Other exemplary embodiments are related to a user equipment (UE) having a transceiver configured to communicate with a base station and a processor communicatively coupled to the transceiver and configured to perform operations. The operations include identifying an indication in response to uplink data, the indication indicating that a first packet was not successfully delivered to a receiving entity, determining that one or more packets associated with the first packet are to be dropped by the UE based on at least the indication, wherein the first packet and the one or more packets associated with the first packet are part of a same packet data unit (PDU) set or a different PDU set and dropping the one or more packets associated with the first packet.

Still further exemplary embodiments are related to a processor of a base station configured to perform operations, The operations include generating configuration information comprising information instructing a user equipment (UE) to drop at least one second packet that is associated with a first packet that is not delivered successfully within a packet delay budget (PDB) and sending the configuration information to the UE.

Additional exemplary embodiments are related to a base station comprises a transceiver configured to communicate with a user equipment (UE) and a processor communicatively coupled to the transceiver and configured to perform operations. The operations include generating configuration information comprising information instructing a user equipment (UE) to drop at least one second packet that is associated with a first packet that is not delivered successfully within a packet delay budget (PDB) and sending the configuration information to the UE.

### BRIEF DESCRIPTION OF THE DRAWINGS

FIG. 1 shows an example of two consecutive packet data unit (PDU) sets each comprising multiple packets according to various exemplary embodiments.

FIG. 2 shows an exemplary network arrangement according to various exemplary embodiments.

FIG. 3 shows an exemplary user equipment (UE) according to various exemplary embodiments.

FIG. 4 shows a method for operating the hybrid automatic request (HARQ) negative acknowledgement (NACK) counter according various exemplary embodiments.

FIG. 5 shows an example abstract syntax notation one (ASN.1) for a packet data convergence protocol (PDCP)-Config information element (IE) comprising the exemplary packetDroppingNACKCounter IE introduced herein.

FIG. 6 shows an exemplary medium access control (MAC) control element (CE) according to various exemplary embodiments.

FIG. 7 shows an exemplary MAC CE according to various exemplary embodiments.

### DETAILED DESCRIPTION

The exemplary embodiments may be further understood with reference to the following description and the related appended drawings, wherein like elements are provided with the same reference numerals. The exemplary embodiments relate to proactive uplink packet dropping.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

Those skilled in the art will understand that a fifth generation (5G) new radio (NR) network may support packet data unit (PDU set) level integrated transmission for extended reality (XR) use cases. Throughout this description, a PDU set may comprise multiple packets including at least one critical packet. If the critical packet is not successfully delivered, the other packets in the PDU set may not be useful to the application layer of the receiving entity even if they are successfully delivered. In some embodiments, a PDU set may include the critical packet and one or more associated packets. In other embodiments, all packets of PDU set may be considered a critical packet where the application layer cannot tolerate delivery failure of any packet of this PDU set. The exemplary embodiments are described with regard to the UE configured to transmit PDU sets in the uplink. Reference to the term PDU set and critical packet are merely provided for illustrative purposes, different entities may refer to similar concepts by a different name. For instance, a PDU set may also be referred to as an application data unit (ADU) or a frame.

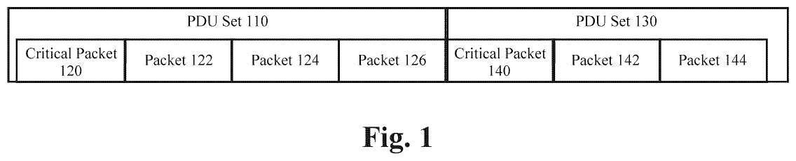

FIG. 1 shows an example of two consecutive PDU sets each comprising multiple packets according to various exemplary embodiments. PDU set 110 includes four packets 120-126 where packet 120 is a critical packet and packets 122-126 are associated with the critical packet 120. PDU set 130 includes three packets 140-144 where packet 140 is the critical packet and packets 142-144 are associated with the critical packet 142. PDU sets 110 and 130 are provide as a general example to demonstrate that consecutive PDU sets may have a different number of packets. However, this example is not intended to limit the exemplary embodiments in any way. The exemplary embodiments may apply to one or more PDU sets each comprising at least one critical packet and any appropriate number of associated packets arranged in any appropriate manner. It should also be understood that a PDU set may also include other information in addition to the packets.

In some embodiments, whether a packet is considered as critical or not depends on how many packets in the corresponding PDU set are already successfully delivered. For example, an application may require that a certain number packets or a certain percentage of packets in a PDU set are successfully delivered. Thus, if a required minimum number of packets in a PDU set are already successfully delivered, none of the remaining packets in the PDU set may be considered critical. Conversely, if the required minimum number of packets in a PDU set are not yet successfully delivered, each of the remaining packets in the PDU set may be considered as critical.

As mentioned above, if at least one critical packet of a PDU set cannot be successfully delivered to the receiving entity, the other remaining packets in the PDU set may be useless to the receiving entity (e.g., application layer). In this type of scenario, it may be beneficial for the UE to drop the remaining packets of the PDU set before the packets are transmitted over the air. To provide another example, the application layer may only utilize a first portion of a PDU set. In this type of scenario, it may be beneficial for the UE to drop a second portion of the PDU set if the first portion of the PDU set has already been successfully delivered. In a further example, there may be an inter-dependent relationship between different PDU sets. For instance, a first PDU set may be essential and a second PDU set may be dependent on the first PDU set. If the first PDU set is not successfully delivered, the second dependent PDU set may be useless to the receiving device. In this type of scenario, it may be beneficial for the UE to drop or continue transmitting one PDU set based on the status of another PDU set. Examples provided throughout this disclosure are described with regard to the UE proactively dropping uplink packets of a same or different PDU set.

As mentioned above, the exemplary embodiments are described with regard to XR over 5G. Those skilled in the art will understand that XR is an umbrella term for different types of realities such as, but not limited to, virtual reality (VR), augmented reality (AR) and mixed reality (MR) which may provide a user with an immersive experience. For XR applications, radio link control (RLC) entity for 5G radio access may be configured in unacknowledged mode (UM) to satisfy certain latency requirements. However, RLC level acknowledgement feedback is not provided in UM and thus, the transmitter may not be aware of whether a packet has been successfully delivered or not. To circumvent this issue with RLC UM and support proactive uplink packet dropping, a medium access control (MAC) level hybrid automatic repeat request (HARQ) mechanism may be utilized (which can be utilized regardless of the RLC mode). As will be described in more detail below, the exemplary embodiments introduce a HARQ negative acknowledgement (NACK) counter that may be utilized to provide the basis for when proactive uplink packet dropping is to be performed.

In another aspect, the exemplary embodiments relate to MAC behavior for proactive uplink packet dropping. In addition, the exemplary embodiments introduce new MAC CEs that may be used by the exemplary proactive packet dropping mechanisms described herein. The exemplary embodiments may be used independently from one another, in conjunction with other currently implemented packet dropping mechanisms, in conjunction with future implementations of packet dropping mechanisms or independently from other packet dropping mechanisms. Each of the exemplary aspects will be described in detail below.

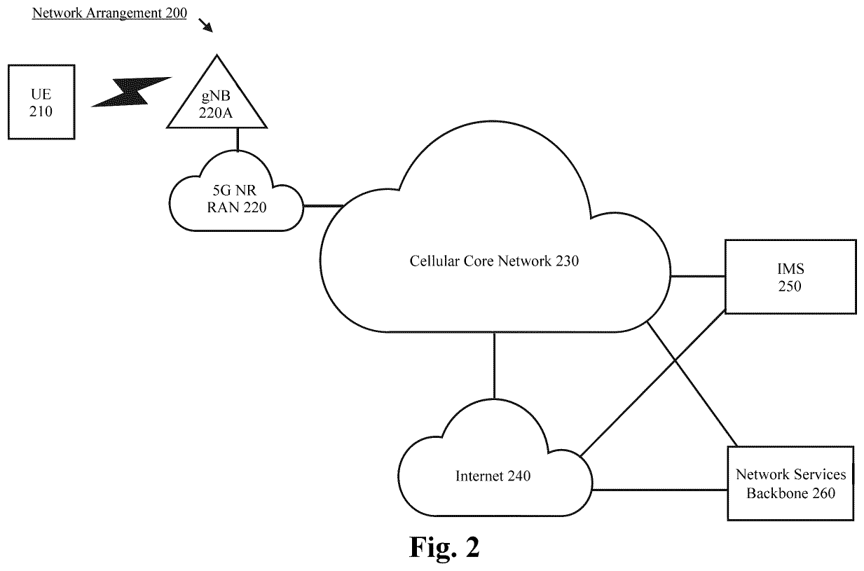

FIG. 2 shows an exemplary network arrangement 200 according to various exemplary embodiments. The exemplary network arrangement 200 includes a UE 210. Those skilled in the art will understand that the UE 210 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 210 is merely provided for illustrative purposes.

The UE 210 may be configured to communicate with one or more networks. In the example of the network arrangement 200, the network with which the UE 210 may wirelessly communicate is a 5G NR radio access network (RAN) 220. However, the UE 210 may also communicate with other types of networks (e.g., 5G cloud RAN, a next generation RAN (NG-RAN), a long term evolution (LTE) RAN, a legacy cellular network, a wireless local area network (WLAN), etc.) and the UE 210 may also communicate with networks over a wired connection. With regard to the exemplary embodiments, the UE 210 may establish a connection with the 5G NR RAN 220. Therefore, the UE 210 may have at least a 5G NR chipset to communicate with the NR RAN 220.

The 5G NR RAN 220 may be a portion of a cellular network that may be deployed by a network carrier (e.g., Verizon, AT&T, T-Mobile, etc.). The 5G NR RAN 220 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 210 to connect to the 5G NR RAN 220. For example, as discussed above, the 5G NR RAN 220 may be associated with a particular cellular provider where the UE 210 and/or the user thereof has a contract and credential information (e.g., stored on a SIM card). Upon detecting the presence of the 5G NR RAN 220, the UE 210 may transmit the corresponding credential information to associate with the 5G NR RAN 220. More specifically, the UE 210 may associate with a specific base station, e.g., the gNB 220A.

The network arrangement 200 also includes a cellular core network 230, the Internet 240, an IP Multimedia Subsystem (IMS) 250, and a network services backbone 260. The cellular core network 230 may refer an interconnected set of components that manages the operation and traffic of the cellular network. It may include the evolved packet core (EPC) and/or the 5G core (5GC). The cellular core network 230 also manages the traffic that flows between the cellular network and the Internet 240. The IMS 250 may be generally described as an architecture for delivering multimedia services to the UE 210 using the IP protocol. The IMS 250 may communicate with the cellular core network 230 and the Internet 240 to provide the multimedia services to the UE 210. The network services backbone 260 is in communication either directly or indirectly with the Internet 240 and the cellular core network 230. The network services backbone 260 may be generally described as a set of components (e.g., servers, network storage arrangements, etc.) that implement a suite of services that may be used to extend the functionalities of the UE 210 in communication with the various networks.

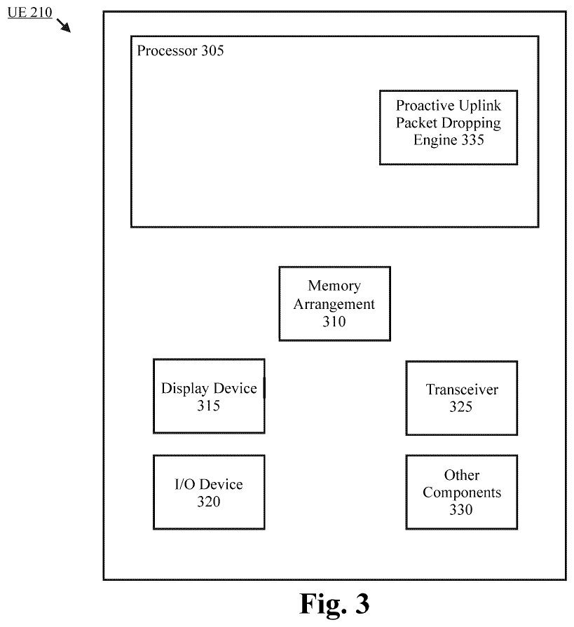

FIG. 3 shows an exemplary UE 210 according to various exemplary embodiments. The UE 210 will be described with regard to the network arrangement 200 of FIG. 2. The UE 210 may include a processor 305, a memory arrangement 310, a display device 315, an input/output (I/O) device 320, a transceiver 325 and other components 330. The other components 330 may include, for example, an audio input device, an audio output device, a power supply, a data acquisition device, ports to electrically connect the UE 210 to other electronic devices, etc.

The processor 305 may be configured to execute a plurality of engines of the UE 210. For example, the engines may include a proactive uplink packet dropping engine 335. The proactive uplink packet dropping engine 335 may perform various operations related to packet dropping such as, but not limited to, receiving packet dropping configuration information, determining that a critical packet cannot be successfully delivered, operating a HARQ NACK counter and performing uplink packet dropping.

The above referenced engine 335 being an application (e.g., a program) executed by the processor 305 is merely provided for illustrative purposes. The functionality associated with the engine 335 may also be represented as a separate incorporated component of the UE 210 or may be a modular component coupled to the UE 210, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 305 is split among two or more processors such as a baseband processor and an applications processor. The exemplary embodiments may be implemented in any of these or other configurations of a UE.

The memory arrangement 310 may be a hardware component configured to store data related to operations performed by the UE 210. The display device 315 may be a hardware component configured to show data to a user while the I/O device 320 may be a hardware component that enables the user to enter inputs. The display device 315 and the I/O device 320 may be separate components or integrated together such as a touchscreen. The transceiver 325 may be a hardware component configured to establish a connection with the 5G NR-RAN 220, an LTE-RAN (not pictured), a legacy RAN (not pictured), a WLAN (not pictured), etc. Accordingly, the transceiver 325 may operate on a variety of different frequencies or channels (e.g., set of consecutive frequencies).

According to some aspects, the exemplary embodiments introduce a HARQ NACK counter. The examples provided below are described within the context of the UE 210 using an XR application over 5G with RLC UM. As will be described in detail below, the exemplary MAC level HARQ NACK counter may be used to provide the basis for when proactive uplink packet dropping is to be performed.

The UE 210 may use the exemplary HARQ NACK counter to track implicit HARQ NACKs. Throughout this description, an implicit NACK may refer to a retransmission grant which implies a HARQ NACK. The UE 210 may also use the exemplary HARQ NACK counter to track explicit HARQ NACKs provided via downlink feedback information (DFI). However, the exemplary embodiments are not limited to any particular type of implicit NACK or an explicit NACK being delivered in any particular manner. The UE 210 may use the exemplary HARQ NACK counter to track any appropriate type of implicit HARQ NACK, explicit HARQ NACK and/or combination thereof.

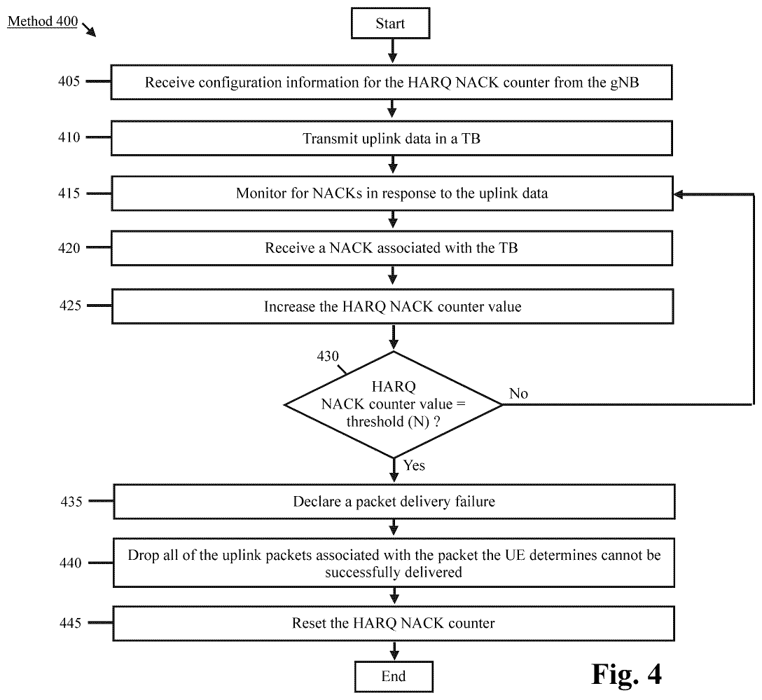

FIG. 4 shows a method 400 for operating the HARQ NACK counter according various exemplary embodiments. The method 400 will be described with regard to the network arrangement 200 of FIG. 2 and the UE 210 of FIG. 3.

In 405, the UE 210 receives configuration information for the HARQ NACK counter from the gNB 220A. The configuration information may include a HARQ NACK threshold (N) that is greater than or equal to one. As will be demonstrated below, when the HARQ NACK counter is equal to the preconfigured HARQ NACK threshold (N), the UE 210 may be triggered to drop one or more packets associated with a same or different PDU set.

The UE 210 may be configured with one or more HARQ NACK counter. In some examples, a single HARQ NACK counter corresponds to one or more uplink data radio bearers (DRBs). Alternatively, or in addition to a HARQ NACK counter configuration per one or more DRBs, an exemplary HARQ NACK counter may be configured on a per quality of service (QoS) flow basis. Thus, the configuration information received by the UE 210 in 405 may be for one or more HARQ NACK counters.

In this example, the HARQ NACK counter is used to track implicit and/or explicit NACKs associated with an uplink transport block (TB) containing data for a DRB referred to below as “DRB-1.” This example is not intended to limit the exemplary embodiments in any way. As mentioned above, the exemplary HARQ NACK counter may be used for one or more DRBs (e.g., DRB-1, DRB-2, etc.) and/or configured on a QoS flow basis.

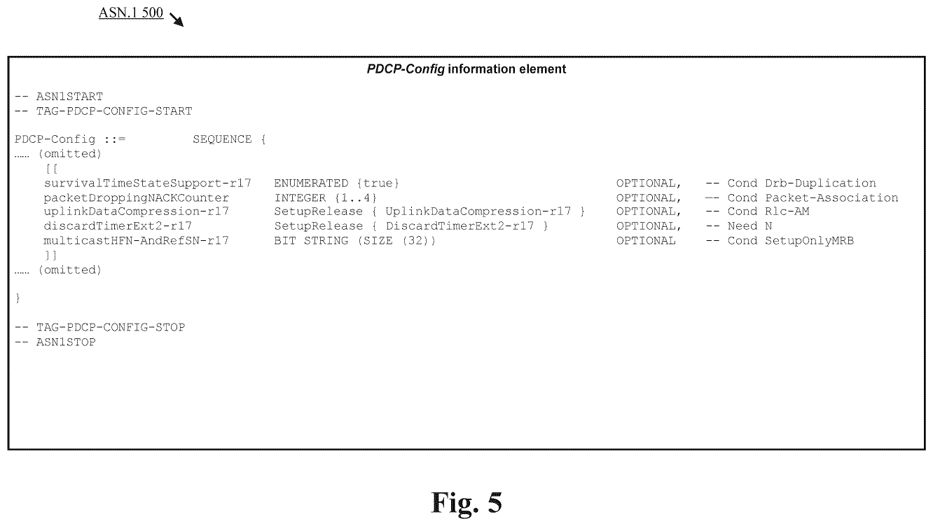

According to some aspects, a new information (IE) is introduced that is configured to provide the UE 210 with the HARQ NACK threshold (N). This IE may inform the UE 210 about how to determine if a first packet for an uplink DRB cannot be delivered successfully within its packet delay budget (PDB) and thus, the UE 210 may proactively drop at least one packet associated with the first packet wherein the at least one packet and the first packet belong to the same or a different PDU set. This exemplary IE is described in more detail below with regard to FIG. 5.

In 410, the UE 210 transmits uplink data in a TB. In 415, the UE 210 monitors for NACKs in response to the uplink data. In 420, the UE 210 receives a NACK associated with the TB containing data from DRB-1. The NACK may be received via a retransmission grant (e.g., implicit NACK) or DFI (e.g., explicit NACK).

In 425, the UE 210 increases the HARQ NACK counter value in response to the NACK received in 420. In 430, the UE 210 determines whether the HARQ NACK counter value is equal to the HARQ NACK threshold (N). If the NACK counter value is less than the HARQ NACK threshold (N), the method 400 returns to 415. If the NACK counter value is equal to the HARQ NACK threshold (N), the method 400 continues to 435.

In 435, the UE 210 declares a packet delivery failure for DRB-1. That is, when (N) retransmission grants and/or DFI are received for a TB containing data from DRB-1, the UE 210 may declare a packet delivery failure. When a packet delivery failure is declared, the UE 210 may consider that the data from DRB-1 in the TB cannot be delivered successfully.

In 440, the UE 210 drops all of the uplink packets associated with the packet the UE 210 determines cannot be successfully delivered, e.g., packets belonging to the same PDU set, packets belonging to a one or more different PDU sets that are dependent on a first PDU set, a combination thereof, etc. t. In 445, the UE 210 resets the HARQ NACK counter. If the UE 210 is still utilizing DRB-1 for uplink information that method 400 may be repeated.

Upon reception of a HARQ NACK, the UE 210 knows which HARQ process corresponds to the HARQ NACK. Accordingly, the UE 210 may identify whether the HARQ NACK is for a critical packet. In some embodiments, a PDU set may include a single critical packet and the HARQ NACK counter may be specific to that critical packet. In other embodiments, each packet of a PDU set may be considered a critical packet. In further embodiments, like in the example provided above, whether a packet is considered as critical or not depends on how many packets in the corresponding PDU set are already successfully delivered. The exemplary techniques described herein may be applied to critical packets only or may be applied to all packets of a PDU set.

In some embodiments, a configured grant (CG) related timer may also be used to declare a packet failure for one or more DRBs. For example, in unlicensed band operation, a counter may be used to track a number of times the CG retransmission timer expired. The UE 210 may be configured with a threshold value (M) and if the CG retransmission timer expires (M) times, the UE 210 may declare a packet delivery failure for the corresponding DRB (e.g., DRB-1). Like in the method 400, this may trigger the UE 210 to drop at least one uplink packet associated with the packet the UE 210 determines cannot be successfully delivered, e.g., packets belonging to the same PDU set.

In some embodiments, a timer may be used in addition to the exemplary HARQ NACK counter described above. In this approach, the UE 210 may initiate a timer after a physical uplink shared channel (PUSCH) transmission. The UE 210 may declare a packet delivery failure if no explicit acknowledgement (ACK) is received from the gNB 220A after timer expiry. This timer may be a CG retransmission timer, a discontinuous reception (DRX) retransmission timer or a new timer may be utilized for this mechanism.

In some embodiments, if the gNB 220A know the UE 210 is going to drop one or more packets and knows which HARQ processes contain the packets to be dropped, the gNB 220A may send a signal to the UE 210 instructing the UE 210 to perform HARQ process flushing and/or stope a CG related timer running at the UE 210. The signal may be a downlink MAC CE or any other appropriate type of signal.

One or more RRC messages may be used to provide configuration information for the HARQ NACK counter to the UE 210. According to some aspects, the exemplary embodiments introduce an IE that may be used for the configuration of the HARQ NACK counter. This exemplary IE may be referred to as a “packetDroppingNACKCounter.” However, reference to the term packetDroppingNACKCounter is merely provided for illustrative purposes, different entities may refer to a similar concept by a different name.

The packet data convergence protocol (PDCP)-Config IE

may be configured to include the exemplary packetDroppingNACKCounter IE introduced herein. The packetDroppingNACKCounter may indicate the number of retransmission grants to be received for a TB conveying at least one packet from a DRB (e.g., HARQ NACK threshold (N)), before declaring a packet delivery failure (e.g., 435 of the method 400). The packetDroppingNACKCounter field may be optionally present in the PDCP-Config IE when application data unit association relationship is present between packets from this DRB. FIG. 5 shows an example abstract syntax notation one (ASN.1) 500 for a PDCP-Config IE comprising the exemplary packetDroppingNACKCounter IE introduced herein.

In another aspect, the exemplary embodiment relate to MAC behavior with regard to uplink packet dropping. The MAC layer of the UE 210 may decide to stop MAC and/or physical layer (PHY) operations of associated uplink packets that are already processed in the lower later. In some embodiments, the uplink packet dropping may be triggered by the exemplary HARQ NACK counter and/or the other exemplary techniques described above with regard to the method 400 of FIG. 4. In other embodiments, the uplink packet dropping at the UE 210 may be triggered by an indication from a higher layer. This indication may be a NACK for an RLC automatic repeat request (ARQ) process, identifying a sequence number gap along with a timer status (e.g., PDCP discard timer, etc.) or any other appropriate indication.

The following examples are described with regard to one or more packets that are to be dropped by the UE 210 but are already being processed in the MAC and/or PHY. In some examples, the UE 210 may determine if the packets to be dropped are multiplexed in a TB together with data from other logical channels (LCHs) and/or certain types of MAC CEs prior to performing the exemplary techniques described below. However, the exemplary embodiments are not limited to this type of example, the UE 210 may flush the TB directly and/or utilize any of the other exemplary techniques described below without checking if other LCHs and/or certain types of MAC CEs are multiplexed in the TB together with the packets to be dropped. For example, the UE 210 may not drop the TB if the MAC CE is a regular buffer status report (BSR) but may drop the TB if the MAC CE is a padding BSR.

When the UE 210 determines that packets to be dropped are not multiplexed in a TB together with data from other LCHs and/or certain type of MAC CEs, one or more of the following exemplary techniques may be performed by the UE 110. In some embodiments, the UE 210 may flush the TB from the HARQ buffer and stop one or more timers corresponding to the HARQ process. The timer may be a CG timer, a CG retransmission timer or any other appropriate type of timer. In some embodiments, the UE 210 may instruct the PHY to stop the related PUSCH transmission if it is ongoing.

In other embodiments, the UE 210 may send a signal to the gNB 220A to notify that all the related HARQ operations for the dropped packets have been stopped. According to some aspects, the exemplary embodiments introduce a new MAC CE that may be utilized by the UE 210 to convey this type of information.

The exemplary MAC CE introduced herein may be used to notify the network that a timer associated with a HARQ process has been stopped at the UE 210. This may allow the gNB to become aware of transport blocks stored with the HARQ processes may be discarded, so the gNB may allocate new transmission for these HARQ processes, or refrain from sending retransmission grants for these HARQ processes. The timer may be a CG timer, a CG retransmission timer or any other appropriate type of timer. To provide an example, the MAC layer of the UE 210 may decide to drop one or more uplink packets that are already multiplexed into different TBs with different HARQ processes. When the TBs are determined to be dropped by the UE 210, a CG timer and/or CG retransmission timer for the corresponding HARQ processes are to be stopped at the UE 210. To avoid misalignment between the gNB 220A and the UE 210 about whether a CG related timer is still running or not, the UE 210 may send a signal to the gNB 220A to notify the network about which HARQ processes are associated with a CG related timer that has been stopped by the UE 210 based on packet dropping.

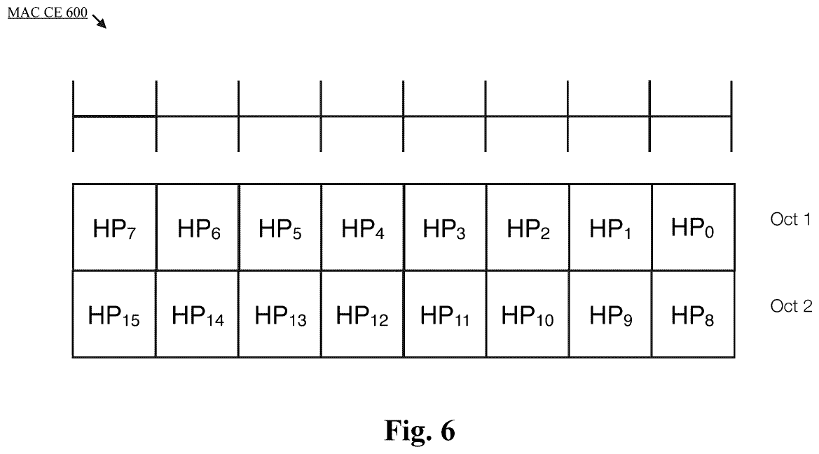

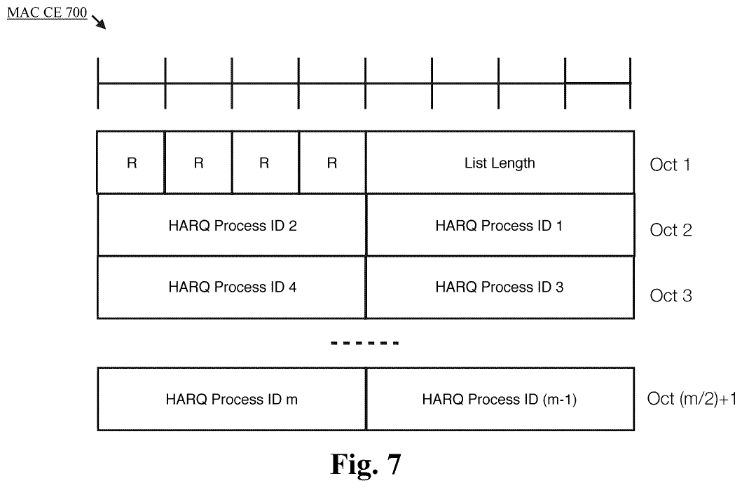

The exemplary MAC CE introduced herein may be referred to as a “CG timer stopping notification MAC CE.” However, reference to this term is provided for illustrative purposes. Different entities may refer to similar concepts by a different name. In some embodiments, the CG timer stopping notification MAC CE may be configured with a bitmap, an example of which is provided below with regard to FIG. 6. In other embodiments, the CG timer stopping notification MAC CE may be configured with a list of HARQ process IDs, an example of which is provided below with regard to FIG. 7.

FIG. 6 shows an exemplary MAC CE 600 according various exemplary embodiments. The exemplary MAC CE 600 comprises a bitmap with multiple bits each corresponding to a different HARQ process and indexed 0-15, e.g., HP₀-HP₁₅. However, reference to the bitmap comprising 16 bits is merely provided for illustrative purposes, the exemplary embodiments may utilize a bitmap comprising any appropriate number of bits.

Each bit (HP) of the MACE CE 600 bitmap represents the status of a CG related timer associated with a j-th HARQ process. When a bit is set to a first value (e.g., 1) this indicates that the corresponding CG related timer has been stopped early by the UE 210 due to packet dropping. When the bit is set to a second value (e.g., 0) this indicates that the corresponding CG related timer is still running. The status of the timer may also imply whether the HARQ buffer of the j-th HARQ process has been flushed by the UE 210. In some examples, the size of the MAC CE 600 is fixed.

FIG. 7 shows an exemplary MAC CE 700 according various exemplary embodiments. In this example, the MAC CE 700 contains a list of HARQ process IDs corresponding to CG related timer that has been stopped early by the UE 210 due to packet dropping. In addition, this may also implicitly indicate which HARQ processes have been flushed by the UE 210. In some examples, the size of the MAC CE 700 is fixed.

The MAC CE 700 may also contain a list length field indicating the number of HARQ process ID entries in the MAC CE. This may enable the receiver to know when it should stop decoding the MAC CE. In addition, the MAC CE 700 may include multiple reserved bits “R.”

### EXAMPLES

In a first example, a user equipment (UE) comprises a transceiver configured to communicate with a base station and a processor communicatively coupled to the transceiver and configured to perform operations comprising identifying an indication in response to uplink data, the indication indicating that a first packet was not successfully delivered to a receiving entity, determining that one or more packets associated with the first packet are to be dropped by the UE based on at least the indication, wherein the first packet and the one or more packets associated with the first packet are part of a same packet data unit (PDU) set or a different PDU set and dropping the one or more packets associated with the first packet.

In a second example, the UE of the first example, wherein determining that one or more packets associated with the first packet are to be dropped by the UE is further based on a hybrid automatic repeat request (HARQ) negative acknowledgement (NACK) counter operated by the UE.

In a third example, the UE of the second example, wherein the HARQ NACK counter is configured on a per data radio bearer (DRB) basis or a per quality of service (QOS) flow basis.

In a fourth example, the UE of the second example, wherein the HARQ NACK counter is configured to count an explicit NACK provided in downlink feedback information (DFI).

In a fifth example, the UE of the second example, wherein the HARQ NACK counter is configured to count an implicit NACK provided in a retransmission grant.

In a sixth example, the UE of the first example, the operations further comprising receiving configuration information comprising a hybrid automatic repeat request (HARQ) negative acknowledgement (NACK) threshold, wherein determining that one or more packets associated with the first packet are to be dropped by the UE is further based on a HARQ NACK counter value being equal to the HARQ NACK threshold.

In a seventh example, the UE of the first example, wherein the configuration information is provided in a packet data convergence protocol (PDCP)-Config information element (IE) comprising a further IE configured to indicate a number of retransmission grants to be received for a transport block (TB) before declaring delivery of the first packet a failure and dropping the one or more packets associated with the first packet.

In an eighth example, the UE of the first example, wherein determining that one or more packets associated with the first packet are to be dropped by the UE is further based on a configured grant (CG) related timer expiring one or more times.

In a ninth example, the UE of the first example, wherein determining that one or more packets associated with the first packet are to be dropped by the UE is further based on a timer operated by the UE that is started after a physical uplink shared channel (PUSCH) and not receiving an explicit acknowledgement (ACK) prior to an expiry of the timer.

In a tenth example, the UE of the first example, the operations further comprising determining, prior to the dropping, whether the one or more packets associated with the first packet are already multiplexed in a transport block (TB).

In an eleventh example, the UE of the tenth example, wherein when the one or more packets associated with the first packet are already multiplexed in the TB, flushing the TB from a medium access control HARQ buffer.

In a twelfth example, the UE of the tenth example, wherein when the one or more packets associated with the first packet are already multiplexed in the TB, stopping at least one configured grant (CG) related timer corresponding to a HARQ process.

In a thirteenth example, the UE of the tenth example, wherein when the one or more packets associated with the first packet are already multiplexed in the TB, instructing a physical layer (PHY) to stop an on-going physical uplink shared channel (PUSCH) transmission.

In a fourteenth example, the UE of the tenth example, wherein when the one or more packets associated with the first packet are already multiplexed in the TB, transmitting a medium access control (MAC) control element (CE) to a base station indicating a status of one or more configured grant (CG) related timers.

In a fifteenth example, the UE of the fourteenth example, wherein the MAC CE comprises a bitmap and each bit of the bit map corresponds to a different HARQ process ID and indicates whether a corresponding CG related timer is still running at the UE.

In a sixteenth example, the UE of the fourteenth example, wherein the MAC CE comprises a list of HARQ process IDs that are each configured with an associated configured grant (CG) related timer that has stopped running at the UE due to packet dropping.

In a seventeenth example, the UE of the first example, the operations further comprising flushing one or more HARQ processes and transmitting a medium access control (MAC) control element (CE) to a base station, the MAC CE indicating one or more HARQ process IDs for the one more HARQ processes that have been flushed by the UE.

In an eighteenth example, a method performing any of the operations of the first through seventeenth examples.

In a nineteenth example, a base station comprises a transceiver configured to communicate with a user equipment (UE) and a processor communicatively coupled to the transceiver and configured to perform operations comprising generating configuration information comprising information instructing a user equipment (UE) to drop at least one second packet that is associated with a first packet that is not delivered successfully within a packet delay budget (PDB) and sending the configuration information to the UE.

In a twentieth example, the base station of the nineteenth example, wherein the information comprises a hybrid automatic repeat request (HARQ) negative acknowledgement (NACK) threshold.

In a twenty first example, the base station of the nineteenth example, wherein the configuration information is provided in a packet data convergence protocol (PDCP)-Config information element (IE) comprising a further IE configured to indicate a number of retransmission grants to be received for a transport block (TB) before declaring delivery of the first packet a failure.

In a twenty second example, the base station of the twenty first example, wherein the operations further comprise receiving, from the UE, a medium access control (MAC) control element (CE) indicating a status of one or more configured grant (CG) related timers.

In a twenty third example, the base station of the twenty second example, wherein the MAC CE comprises (i) a bitmap and each bit of the bit map corresponds to a different HARQ process ID and indicates whether a corresponding CG related timer is still running at the UE or (ii) a list of HARQ process IDs that are each configured with an associated CG related timer that has stopped running at the UE due to packet dropping.

In a twenty fourth example, the base station of the nineteenth example, the operations further comprising receiving, from the UE, a medium access control (MAC) control element (CE) indicating one or more HARQ process IDs for one more HARQ processes that have been flushed by the UE.

In an twenty fourth h example, a method performing any of the operations of the nineteenth through twenty fourth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
identifying an indication in response to uplink data, the indication indicating that a first packet was not successfully delivered to a receiving entity;
determining that one or more packets associated with the first packet are to be dropped by the UE based on at least the indication, wherein the first packet and the one or more packets associated with the first packet are part of a same packet data unit (PDU) set or a different PDU set; and
dropping the one or more packets associated with the first packet.

2. The processor of claim 1, wherein determining that one or more packets associated with the first packet are to be dropped by the UE is further based on a hybrid automatic repeat request (HARQ) negative acknowledgement (NACK) counter operated by the UE.

3. The processor of claim 2, wherein the HARQ NACK counter is configured on a per data radio bearer (DRB) basis or a per quality of service (QoS) flow basis.

4. The processor of claim 2, wherein the HARQ NACK counter is configured to count an explicit NACK provided in downlink feedback information (DFI).

5. The processor of claim 2, wherein the HARQ NACK counter is configured to count an implicit NACK provided in a retransmission grant.

6. The processor of claim 1, the operations further comprising:
receiving configuration information comprising a hybrid automatic repeat request (HARQ) negative acknowledgement (NACK) threshold, wherein determining that one or more packets associated with the first packet are to be dropped by the UE is further based on a HARQ NACK counter value being equal to the HARQ NACK threshold.

7. The processor of claim 6, wherein the configuration information is provided in a packet data convergence protocol (PDCP)-Config information element (IE) comprising a further IE configured to indicate a number of retransmission grants to be received for a transport block (TB) before declaring delivery of the first packet a failure and dropping the one or more packets associated with the first packet.

8. The processor of claim 1, wherein determining that one or more packets associated with the first packet are to be dropped by the UE is further based on a configured grant (CG) related timer expiring one or more times.

9. The processor of claim 1, wherein determining that one or more packets associated with the first packet are to be dropped by the UE is further based on a timer operated by the UE that is started after a physical uplink shared channel (PUSCH) and not receiving an explicit acknowledgement (ACK) prior to an expiry of the timer.

10. The processor of claim 1, the operations further comprising:
determining, prior to the dropping, whether the one or more packets associated with the first packet are already multiplexed in a transport block (TB).

11. The processor of claim 10, wherein when the one or more packets associated with the first packet are already multiplexed in the TB, flushing the TB from a medium access control HARQ buffer.

12. The processor of claim 10, wherein when the one or more packets associated with the first packet are already multiplexed in the TB, stopping at least one configured grant (CG) related timer corresponding to a HARQ process.

13. The processor of claim 10, wherein when the one or more packets associated with the first packet are already multiplexed in the TB, instructing a physical layer (PHY) to stop an on-going physical uplink shared channel (PUSCH) transmission.

14. The processor of claim 10, wherein when the one or more packets associated with the first packet are already multiplexed in the TB, transmitting a medium access control (MAC) control element (CE) to a base station indicating a status of one or more configured grant (CG) related timers.

15. The processor of claim 14, wherein the MAC CE comprises a bitmap and each bit of the bit map corresponds to a different HARQ process ID and indicates whether a corresponding CG related timer is still running at the UE.

16. The processor of claim 14, wherein the MAC CE comprises a list of HARQ process IDs that are each configured with an associated configured grant (CG) related timer that has stopped running at the UE due to packet dropping.

17. The processor of claim 1, the operations further comprising:
flushing one or more HARQ processes; and
transmitting a medium access control (MAC) control element (CE) to a base station, the MAC CE indicating one or more HARQ process IDs for the one more HARQ processes that have been flushed by the UE.

18. A processor of a base station configured to perform operations comprising:
generating configuration information comprising information instructing a user equipment (UE) to drop at least one second packet that is associated with a first packet that is not delivered successfully within a packet delay budget (PDB); and
sending the configuration information to the UE.

19. The processor of claim 18, wherein the information comprises a hybrid automatic repeat request (HARQ) negative acknowledgement (NACK) threshold.

20. The processor of claim 18, wherein the configuration information is provided in a packet data convergence protocol (PDCP)-Config information element (IE) comprising a further IE configured to indicate a number of retransmission grants to be received for a transport block (TB) before declaring delivery of the first packet a failure.

21-23. (canceled)
